(19) United States
(12) Patent Application Publication
(10) Pub. No.: US 2013/0002543 A1
(43) Pub. Date: Jan. 3, 2013

(54) INTERACTIVE PRESENTATION SYSTEM OF ELECTRONIC READING DEVICE WITH ON-PAPER WINDOW SYSTEM

(76) Inventor: Yim wai Yau, Hong Kong (CN)

(21) Appl. No.: 13/634,884

(22) PCT Filed: Mar. 22, 2011
(86) PCT No.: PCT/CN2011/072023

§ 371 Date: Sep. 14, 2012

(30) Foreign Application Priority Data
Mar. 23, 2010 (CN) 201020140338.4
Mar. 23, 2010 (CN) 201020168752.6

(51) Int. Cl. G06F 3/01

(52) U.S. Cl. 345/156

(57) ABSTRACT

The invention relates to an electronic reading device that can be used in combination with print media, and more particularly, to an interactive presentation system for an electronic reading device having an on-paper window system. The interactive presentation system is composed of a plurality of electronic reading device. One of the electronic reading devices is set as a leading device, and the others of the electronic reading devices are set as auxiliary devices. The interactive presentation system can read various data from media, having information messages, and an electronic coordinate circuit, respectively. The data can be transmitted to a circuit substrate for a central processor, which is provided with a storage, and then processed into combined data of electronic files. Thereby, associated information can be readily searched for and read using a connected electronic reader or a projector for projecting it to a projecting board.

### BACKGROUND OF THE DISCLOSURE

a) Field of the Disclosure

The invention relates to an electronic reading device that can be used in combination with print media, and more particularly, to an interactive presentation system for an electronic reading device having an on-paper window system. The interactive presentation system includes an electronic coordinate device, a circuit substrate for a central processor, which is provided with a storage, and multiple sets of optoelectronic devices. The interactive presentation system can read various data from media, having information messages, and an electronic coordinate circuit, respectively. The data can be transmitted to the circuit substrate for the central processor and then processed into combined data of electronic files. Thereby, associated information can be readily searched for and read using a connected electronic reader or a projector for projecting it to a projecting board.

b) Brief Description of the Related Art

People cannot live without words, figures, sounds and videos for recordation and dissemination of information, but expression of print media far cannot meet actual human needs. Accordingly, experts propose a new concept of “e-paper” such that print media can be combined with audio and video data. Paper reading and electronic reading will be coexistence.

Combination of print media and electronic media is necessary for people and is a trend for development of culture industries. Accordingly, in many years, researchers around the world tirelessly pursued technological breakthroughs.

Various technologies associated with e-paper combination, such as BAR technology, OCR technology, OID technology and X-Y technology, are provided on market. However, these technologies have limitations. Even though researchers have pursued these technologies for many years, passive limitations of these technologies cannot be broken through and thus market utilization rate of these technologies is very low.

Interactive presentation systems for tuition or conference employ a circuit interconnection technology and have no effective solution to complementary use of print media combined with electronic media. Even though numerous electronic reading products on market solve the above problems from a certain aspect, but they are limited to be used in a specific scope.

Some people in society promote electronic readers or laptops acting as electronic reading devices, such as electronic bag or electronic journal, instead of traditional reading manners of paper textbooks and paper journals. For example, do educators and students, when using electronic reading devices, still need to bring traditional paper textbooks? How can people after joining a conference continue to refer to contents in related journals? This promotion is pursued for paperless environments and has been proved to be ineffective for long years.

The applicant provides an effective solution to use of print media combined with electronic media and owns multiple patents for the technology. For example, patent application No. 200410079216.8, entitled as “multi-page foldable data book with PDA”, patent application No. 200510065313.6, entitled as “multifunctional covering device mountable onto PDA”, and patent application No. 200510088377.8, entitled as “braille-word writing device having information processing function” are owned.

Based on a conventional electronic-coordinate technology and a two-dimensional code technology, an on-paper window system fully equivalent to usage conditions of traditional technologies is created.
1. In accordance with the invention, the amount of usable code sources, that is, the amount of multiplying the number of Y-coordinates by the number of X-coordinates is ten times or hundreds times more than that for the traditional two-dimensional code.
2. In accordance with the invention, the number of samples to be determined is less than that for the two-dimensional code. Thus, a structure of an invisible code is simpler than that of the two-dimensional code.

The on-paper window system provides solutions to technologies associated with traditional print reading and electronic reading. Print media on market are numerous, but more and more technologies are still to be provided to solve issues of code sources, costs, ease of use and so on such that use of traditional print reading combined with electronic reading can be effective and popular.

### SUMMARY OF THE DISCLOSURE

The invention provides a reading tool used for education and learning sharing such that related reference can be readily found.

In order to achieve the above purpose, the present invention proposes an interactive presentation system for an electronic reading device having an on-paper window system. The interactive presentation system is composed of a plurality of electronic reading device, wherein the electronic reading device is composed of a reading panel and an electronic card reader, wherein the reading panel has a panel surface having media placed thereon, the electronic card reader includes an electronic coordinate device, a circuit substrate for a central processor, which is provided with a storage, and multiple sets of optoelectronic devices. The electronic coordinate device is composed of an electronic coordinate circuit and an electromagnetic-wave circuit configured to emit a signal with a fixed frequency. A first set of optoelectronic device and the electromagnetic-wave circuit compose an optoelectronic reading device. The optoelectronic reading device and a second set of optoelectronic device are configured to read various data from media, having information messages, and the electronic coordinate circuit, respectively. The data is configured to be transmitted to the circuit substrate for the central processor and then processed into combined data of electronic files. Thereby, related information can be readily searched for and read using a connected electronic reading product.

One of the electronic reading devices is set as a leading device, and the others of the electronic reading devices are set as auxiliary devices. The reading panel, like a panel-shaped body, is divided into a reading and sensing area and non reading and sensing area, wherein the reading and sensing area corresponds to an effective sensing region of the electronic coordinate circuit in the reading panel. The electronic coordinate circuit is arranged with multiple electronic antenna-array type of circuit substrates having multiple electronic antenna loops alternately formed and overlain with one another. The electronic antenna-array type of circuit substrates include a metal line, extending in a direction of X-axis, and another metal line, extending in a direction of Y-axis and across the direction of X-axis, that compose an array type of the antenna loops. The antenna-array type of circuit substrates are configured to sense the signal with the fixed frequency emitted from the electromagnetic-wave circuit and have contacts electrically connected to A/D devices of the circuit substrate for the central processor.

The reading panel, like a panel-shaped body, is composed of a left panel and a right panel. The left and light panels are configured to join with each other and move apart from a center line such that a clipping space can be kept between the left and right panels. The reading panel is divided into the reading and sensing area and non reading and sensing area, wherein the reading and sensing area corresponds to an effective sensing region of the electronic coordinate circuit in the reading panel. The left and right panels include electrically conductive devices, having opposite polarization, at neighboring sidewalls thereof and are electrically connected to the circuit substrate for the central processor. The electronic coordinate circuit is arranged with multiple electronic antenna-array type of circuit substrates having multiple electronic antenna loops alternately formed and overlain with one another. The electronic antenna-array type of circuit substrates include a metal line, extending in a direction of X-axis, and another metal line, extending in a direction of Y-axis and across the direction of X-axis, that compose an array type of the antenna loops. The antenna-array type of circuit substrates are configured to sense the signal with the fixed frequency emitted from the electromagnetic-wave circuit and have contacts electrically connected to A/D devices of the circuit substrate for the central processor.

Each of the left and right panels includes at least a magnetic block at a corresponding neighboring sidewall thereof, wherein the magnetic blocks of the left and right panels have opposite polarization. A standalone electronic device is set at a panel surface of a non information-sensing area of the reading panel. The media are divided into an information-sensing region and the non information-sensing region corresponding to the reading and sensing area and non reading and sensing area of the reading panel, respectively.

The media are printed with invisible codes arranged with multiple minute symbol units printed using a fluorescent ink having optical response to an infrared ray from an infrared emitter.

The media having different information-sensing region cannot be printed with the same invisible code. The non information-sensing region is printed with an invisible code. Each invisible code is arranged with multiple minute symbol units and is printed using a fluorescent ink having optical response to an infrared ray from an infrared emitter.

The first set of optoelectronic device includes the infrared emitter, an image capturing device and a photoelectric conversion circuit, wherein the image capturing device is configured to capture a response image of the invisible code, and the photoelectric conversion circuit is configured to transmit determined data to the circuit substrate for the central processor for processing the determined data. The optoelectronic reading device is arranged with a functional switch and an output circuit.

The second set of optoelectronic device including the infrared emitter, the image capturing device and the photoelectric conversion circuit is placed in an internally hollow body. A through window is set at a front end of the internally hollow body, wherein the infrared emitter is configured to emit an infrared ray to the outside via the through window, and the image capturing device is configured to capture an image via the through window. The image capturing device is configured to capture a response image of the invisible code. The photoelectric conversion circuit is configured to transmit determined data to the circuit substrate for the central processor for processing the determined data.

A small through hole is set at the non reading and sensing area of the reading panel and corresponds to the non information-sensing region of the media. The second set of optoelectronic device is placed in the reading panel and the through window at the second set of optoelectronic device is adjacent to and communicates with the small through hole at the reading panel.

On basis of an original on-paper window system, the electronic card reader employs multiple sets of optoelectronic devices. Thereby, the on-paper window system has powerful efficiency. Data read by the second set of optoelectronic device and data of the original on-paper window system can create geometric combinations for meeting demands of various print media on market. Thus, development of culture industries can be enhanced due to the improved technologic supports.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1A is a schematic view of an interactive presentation system.

FIG. 1B is a schematic view of a reading panel arranged with an electronic coordinate circuit.

FIG. 1C is a schematic view of the reading panel having a medium placed thereon.

FIG. 2A is a schematically plane view of the reading panel.

FIG. 2B is a schematically plane view of the reading panel having left and right panels pushed to be open.

FIG. 2C is a schematic view of a profile structure for an electric paper book.

FIG. 2D is a schematic view of the reading panel clipping the electric paper book.

FIG. 2E is a schematic view of an electronic reading device clipping the electric paper book.

FIG. 3A is a schematic view of a front page of a paper newspaper.

FIG. 3B is a schematic view of a back page of the paper newspaper.

FIG. 3C is a schematic view of an inner page of a paper magazine when opened.

FIG. 3D is a schematic view of cover and bottom pages of the paper magazine when opened.

FIG. 4A is a schematic view of a small hole at the reading panel.

FIG. 4B is a schematic view of a second set of an optoelectronic device.

FIG. 4C is a schematic view of assembling the reading panel and the second set of optoelectronic device.

FIG. 5A is a schematic view of an optoelectronic reading device connected with a physical line.

FIG. 5B is a schematic view of an optoelectronic reading device wireless connected.

FIG. 5C is a reference circuit diagram of an optoelectronic reading device.

FIG. 5D is a schematic view of a principle of reading various data in accordance with the present invention.

FIG. 6A is a first schematic view of application in accordance with a technology of the present invention.

FIG. 6B is a second schematic view of application in accordance with a technology of the present invention.

FIG. 7A is a schematic view of an electronic reader detachable from a frame of the reading panel.

FIG. 7B is a schematic view of the electronic reader rotatable to any angle.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

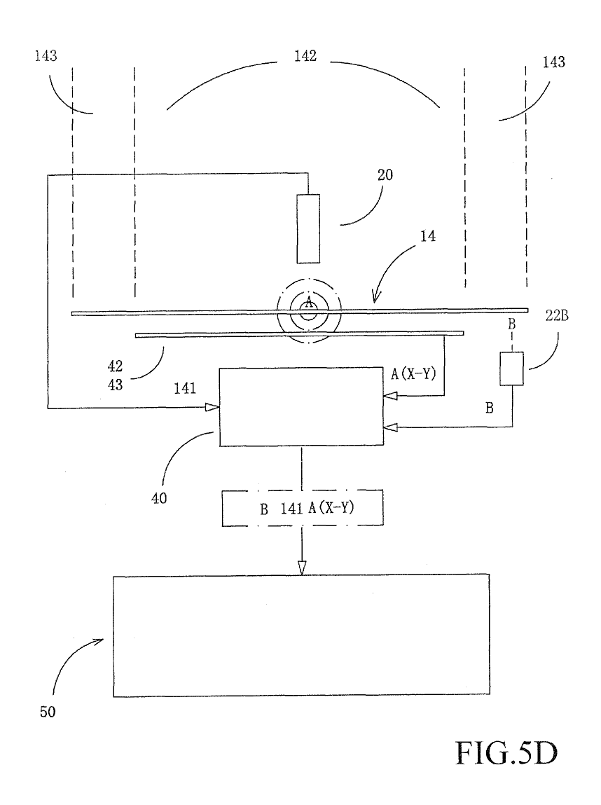

The present invention proposes an interactive presentation system for an electronic reading device having an on-paper window system. The interactive presentation system is composed of a plurality of electronic reading device, wherein the electronic reading device is composed of a reading panel 100 and an electronic card reader, wherein the reading panel 100 has a panel surface having media 14, made of paper or other materials, placed thereon, the electronic card reader includes an electronic coordinate device, a circuit substrate 40 for a central processor, which is provided with a storage, and multiple sets of optoelectronic devices 22. The electronic coordinate device is composed of an electronic coordinate circuit and an electromagnetic-wave circuit 21 configured to emit a signal with a fixed frequency. A first set of optoelectronic device 22A and the electromagnetic-wave circuit 21 compose an optoelectronic reading device 20. FIG. 5C is a reference circuit diagram of the optoelectronic reading device. The optoelectronic reading device 20 and a second set of optoelectronic device 22B are configured to read various data from media, having information messages, and the electronic coordinate circuit, respectively. The data is configured to be transmitted to the circuit substrate 40 for the central processor and then processed into combined data of electronic files. Thereby, related information can be readily searched for and read using a connected electronic reading product, such as computer, handheld computer, handheld electronic reader, electronic learning machine, MP4, mobile phone, television or projector.

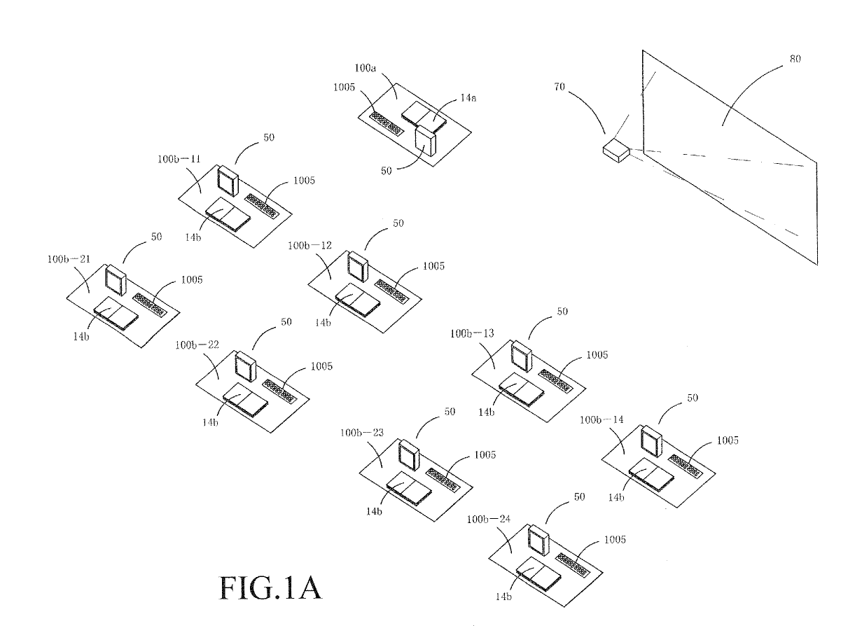

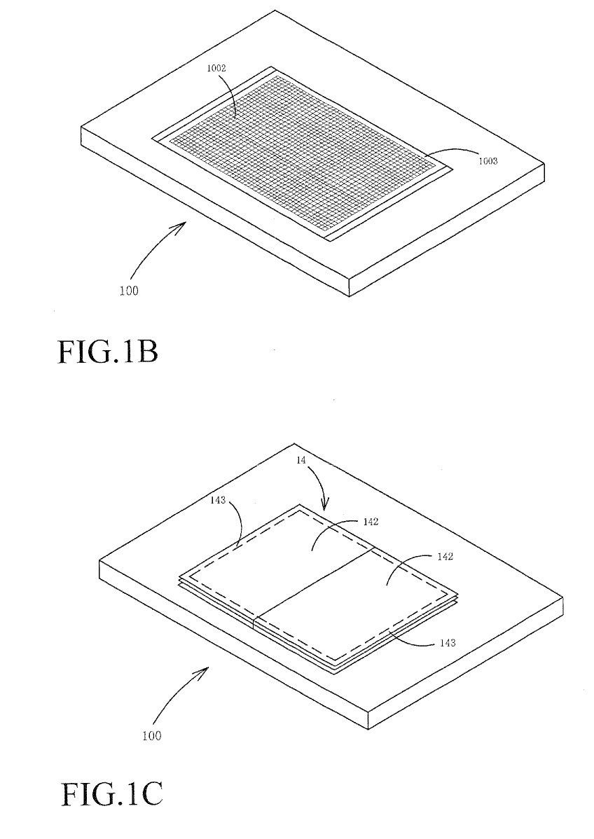

One of the electronic reading devices is set as a leading device, and the others of the electronic reading devices are set as auxiliary devices, as seen in FIG. 1A. The reading panel 100, like a panel-shaped body, is divided into a reading and sensing area 1002 and non reading and sensing area 1003, wherein the reading and sensing area 1002 corresponds to an effective sensing region of the electronic coordinate circuit in the reading panel 100. The electronic coordinate circuit is arranged with multiple electronic antenna-array type of circuit substrates 42 and 43 having multiple electronic antenna loops alternately formed and overlain with one another. The electronic antenna-array type of circuit substrates 42 and 43 include a metal line, extending in a direction of X-axis, and another metal line, extending in a direction of and across the direction of X-axis, that compose an array type of the antenna loops. In accordance with the present invention, the electronic antenna-array type of circuit substrates 42 and 43 can be flexible electrically-conductive films or other materials. The electronic antenna-array type of circuit substrates 42 and 43 are configured to sense the signal with the fixed frequency emitted from the electromagnetic-wave circuit 21 and have contacts electrically connected to A/D devices of the circuit substrate 40 for the central processor.

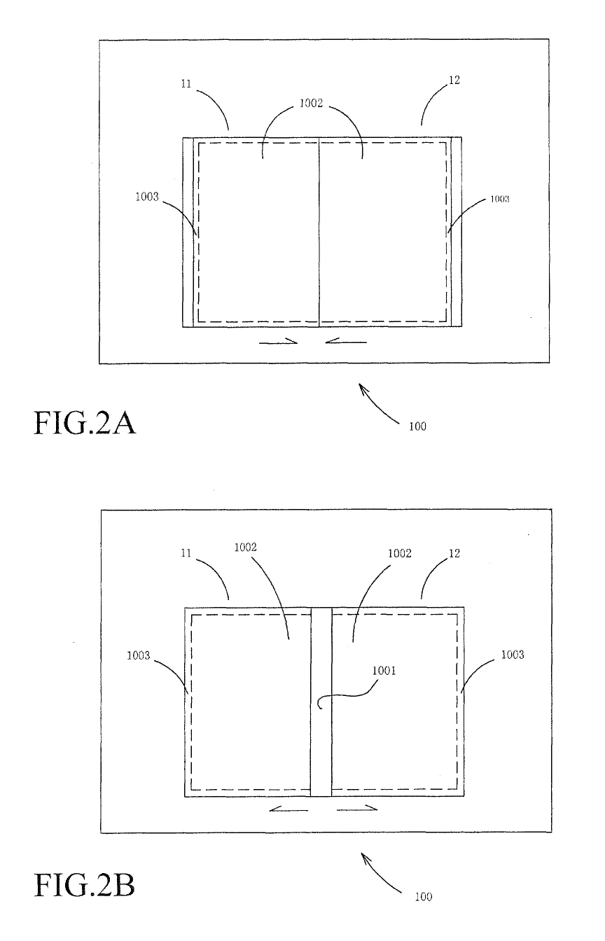

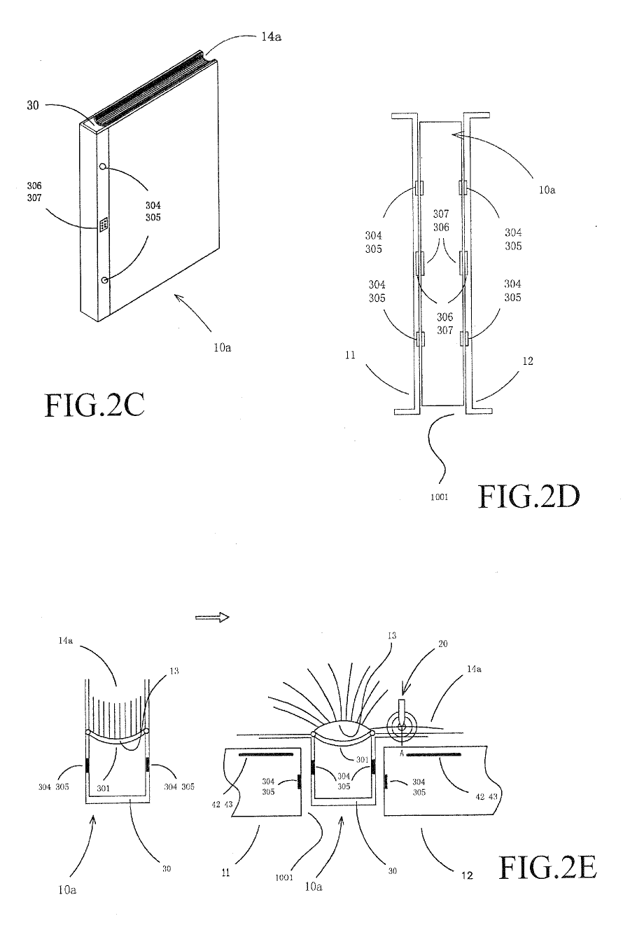

In order to meet various markets, another embodiment of the reading panel is seen in FIGS. 2A and 2B.

The reading panel 100, like a panel-shaped body, is composed of a left panel 11 and a right panel 12. The left and right panels 11 and 12 are configured to join with each other and move apart from a center line such that a clipping space 1001 can be kept between the left and right panels 11 and 12. The reading panel 100 is divided into the reading and sensing area 1002 and non reading and sensing area 1003, wherein the reading and sensing area 1002 corresponds to an effective sensing region of the electronic coordinate circuit in the reading panel 100. The left and right panels 11 and 12 include electrically conductive devices 306 and 307, having opposite polarization, at neighboring sidewalls thereof and are electrically connected to the circuit substrate 40 for the central processor. The electronic coordinate circuit is arranged with the electronic antenna-array type of circuit substrates 42 and 43 having multiple electronic antenna loops alternately formed and overlain with one another. The electronic antenna-array type of circuit substrates include a metal line, extending in a direction of X-axis, and another metal line, extending in a direction of Y-axis and across the direction of X-axis, that compose an array type of the antenna loops. The antenna-array type of circuit substrates are configured to sense the signal with the fixed frequency emitted from the electromagnetic-wave circuit 21 and have contacts electrically connected to A/D devices of the circuit substrate 40 for the central processor.

The present invention can be used in combination with the patent application No. 200820210181.0, entitled as electronic book provided with inner coordinate circuit device and print pages having data codes, owned by the applicant. As a result, a reading effect can be improved.

Referring to FIGS. 2C and 2E, a book 10a is made from a cover joining a paper book, wherein a book ridge pedestal 30 is between joints of the cover and the paper book and joins the cover. The book ridge pedestal 30 movably contacts a contact surface 301 of a book ridge 13 of the paper book.

Referring to FIGS. 2B, 2D and 2E, the clipping space 1001 between the left and right panels 11 and 12 can accommodate the book ridge 13 of the book. Referring to FIG. 2E, in order to overcome an irregularly expanding status of pages 14a of the book 10a and have the pages 14a naturally expand on a surface of the reading panel 100, related contents in the pages 14a can be stably positioned relative to the electronic antenna-array type of circuit substrates 42 and 43 such that points of X-Y coordinates corresponding to relative positions can be precisely determined.

At least a magnetic block 304 or 305 is set at each of two side surfaces of the book ridge pedestal 30 of the clipped book 10a, wherein the magnetic blocks 304 and 305 have opposite polarization. That is, each of the left and right panels 11 and 12 of the reading panel 100 includes at least a magnetic block 304 or 305 at a corresponding neighboring sidewall thereof, wherein the magnetic blocks 304 and 305 have opposite polarization. The magnetic blocks having properties of opposite attraction have the book 10a and the reading panel 100 tightly join together.

Referring to FIG. 2D, the book ridge pedestal 30 of the clipped book 10a is arranged with electrically conductive devices 306 and 307 that can join electrically conductive devices arranged at the reading panel 100 such that an inner circuit of the reading panel 100 can be connected to an inner circuit of the book 10a and thus data in the reading panel 100 and book 10a can be shared to each other.

The clipped book 10a is arranged with an IC card containing a storage for providing various index data that are transmitted to the circuit substrate 40 for the central processor and processed into combined data for building electronic files. Thereby, preset related contents including text, pictures, sound, and video can be readily searched for through the connected electronic reader.

In order to avoid disorder due to the multiple auxiliary devices operating at the same time in case that the number of audiences in a large conference could be even more than a thousand, the leading device, in this embodiment, serves as a controlling platform.

A standalone electronic device is set at a panel surface of a non information-sensing area 143 of the reading panel 100. Referring to FIG. 1A, electronic devices including functional buttons 1005 and an electronic reader 50 can control a screen of the electronic reader of the reading panel 100 such that related reference can be read.

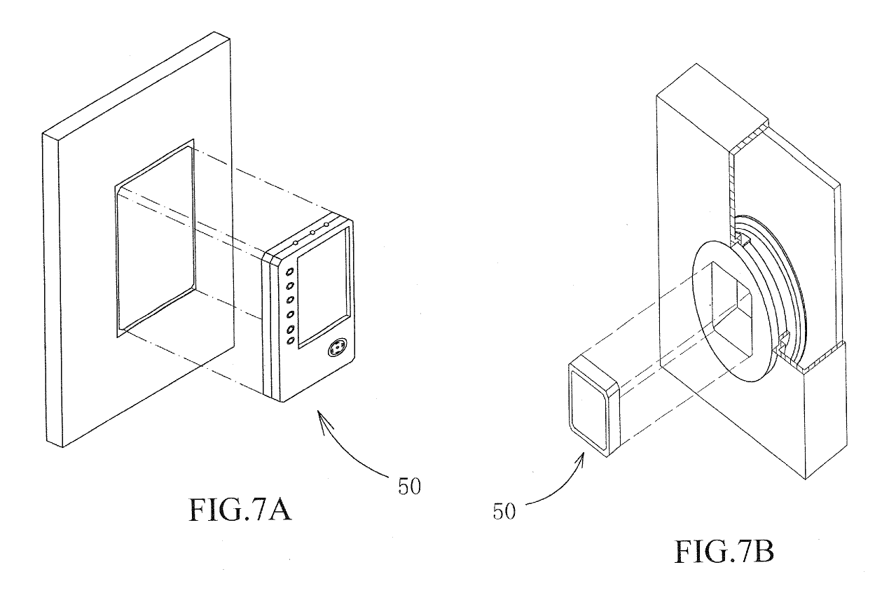

The electronic reader is a standalone device having a complete electronic function therein and is configured to be detachably mounted on a frame of the reading panel 100, as seen in FIG. 7A. The embodiment can be referred to patent application No. 200410015427.5, entitled as multi-functional cover device.

In case that patent application No. 200820001762.3, entitled as rotatable cover device of handheld computer or digital audiovisual device, is applied hereto, the screen of the electronic reader can be rotated to any angle. Thus, a viewing effect can be enhanced, as seen in FIG. 7B.

Data in various media or in different pages of the same medium can be read. The media 14 can be divided into an information-sensing region 142 and the non information-sensing region 143 corresponding to the reading and sensing area 1002 and non reading and sensing area 1003 of the reading panel 100, respectively.

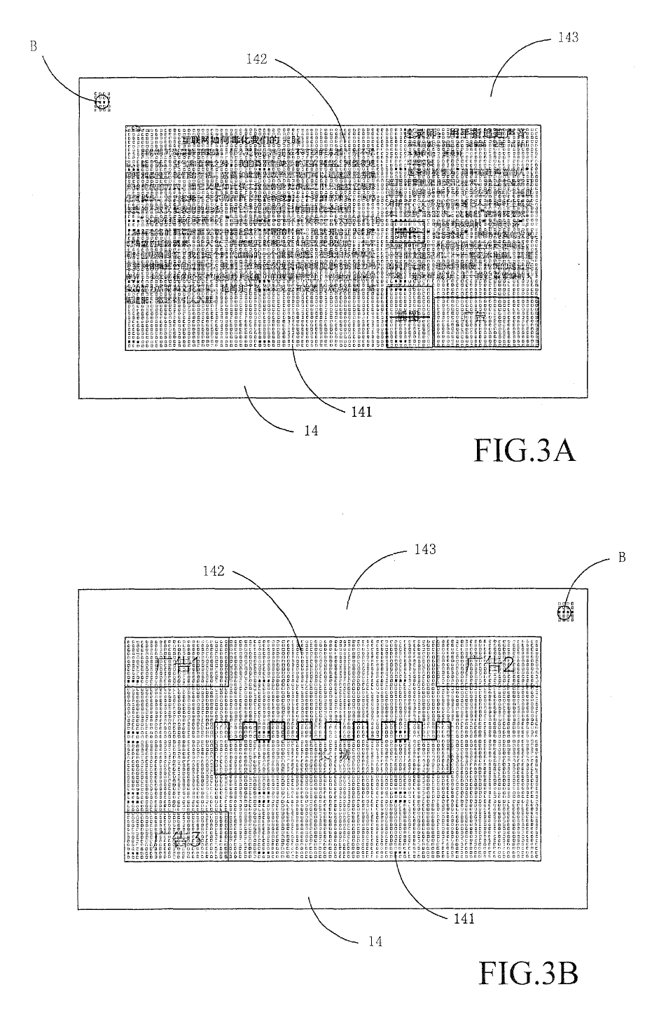

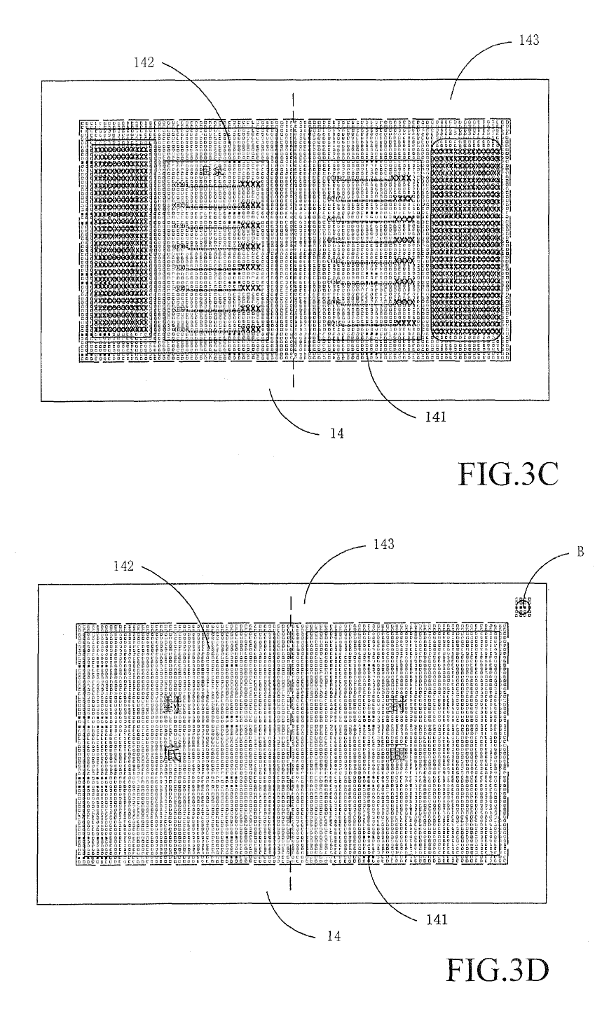

Referring to FIGS. 3A-3D, the media 14 are printed with invisible codes 141 arranged with multiple minute symbol units. The minute symbol units can be a single geometric picture, Arabic numerals, Roman numerals, English letters, text or various combinations of the above mentioned. The minute symbol units are so minute as to be ignored in vision and are printed using a fluorescent ink having optical response to an infrared ray from an infrared emitter. Text and pictures on a surface of the media can be printed using an ink not absorbing an infrared ray and can or cannot overlap the invisible codes 141. Because the minute symbol units are so minute as to be ignored in vision, no aesthetic impact would be caused on a print content.

The invisible codes 141 carry data of a page number that is an important feature for determining various media. In order to prevent reading contents from having mistaken identity due to duplication of code usage, the media 14 having different information-sensing region 142 cannot be printed with the same invisible code 141. According to this specific demand, the media 14 can be printed with different invisible codes 141. The non information-sensing region 143 of the media 14 is printed with an invisible code 141. Each invisible code 141 is arranged with multiple minute symbol units printed using a fluorescent ink having optical response to an infrared ray from an infrared emitter.

Referring to FIGS. 5A and 5B, the first set of optoelectronic device 22A includes the infrared emitter 221, an image capturing device 222 and a photoelectric conversion circuit 223, wherein the image capturing device 222 is configured to capture a response image of the invisible code 141, and the photoelectric conversion circuit 223 is configured to transmit determined data to the circuit substrate 40 for the central processor for processing the determined data. Traditional electronic coordinate circuits have constraints that a pointing and reading medium is smaller than an area of the electronic antenna-array type of circuit substrates but needs be printed with pictures having large areas for enhancing an effect of reading contents.

The optoelectronic reading device 20 is arranged with a functional switch 241 and an output circuit 24. The functional switch 241 can be controlled to select a hybrid use of the optoelectronic devices 22 and electromagnetic-wave circuit 21, a single use of the optoelectronic devices 22 or a single use of the electromagnetic-wave circuit 21 for meeting various reading needs.

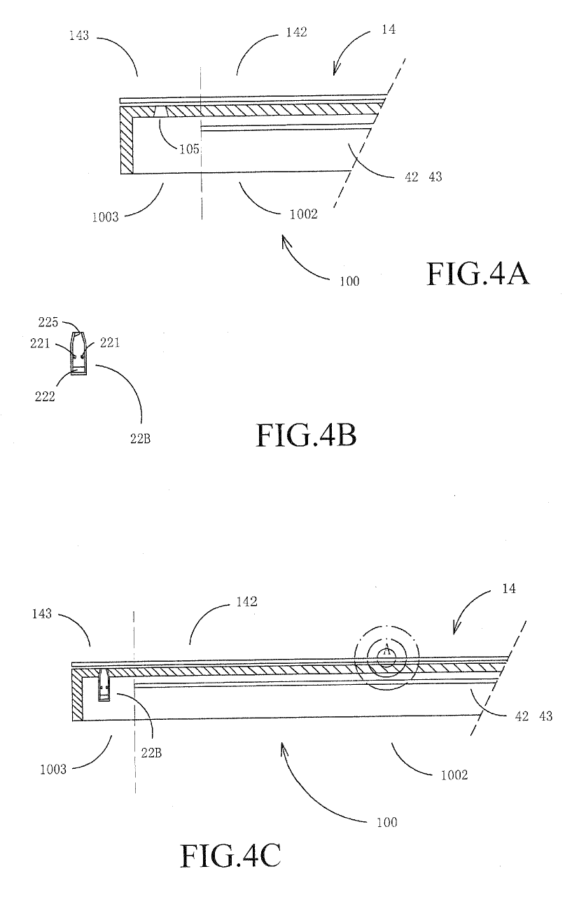

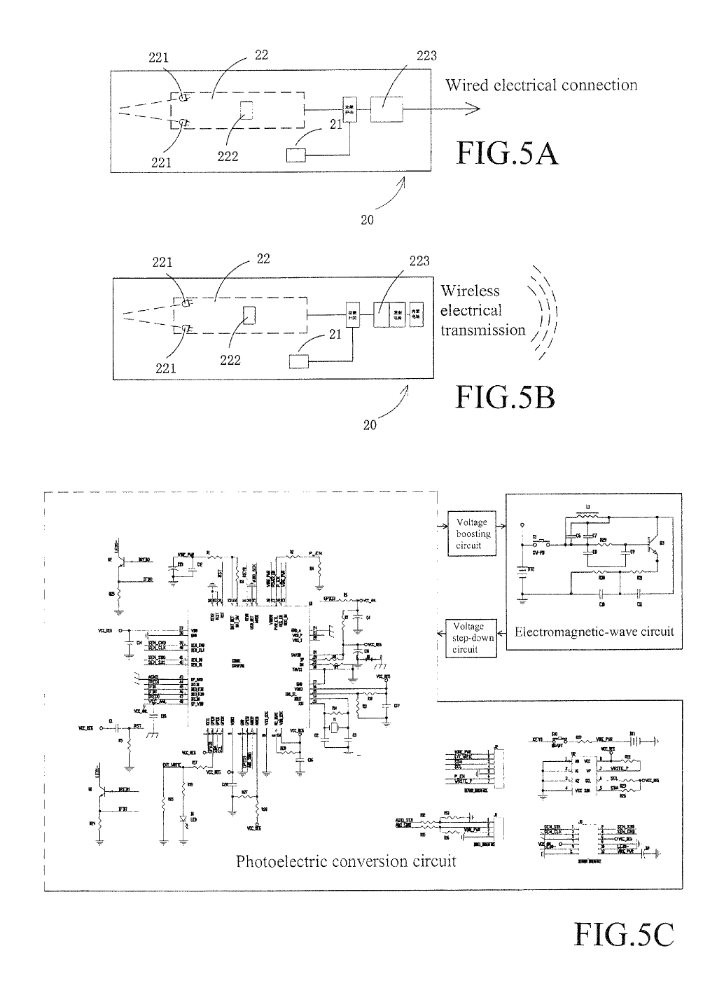

Referring to FIG. 4B, the second set of optoelectronic device 22B including the infrared emitter 221, the image capturing device 222 and the photoelectric conversion circuit 223 is placed in an internally hollow body. A through window 225 is set at a front end of the internally hollow body, wherein the infrared emitter 221 is configured to emit an infrared ray to the outside via the through window 225, and the image capturing device 222 is configured to capture an image via the through window 225. The image capturing device 222 is configured to capture a response image of the invisible code 141. The photoelectric conversion circuit 223 is configured to transmit determined data to the circuit substrate 40 for the central processor for processing the determined data.

Referring to FIG. 4A, a small through hole 105 is set at the non reading and sensing area 1003 of the reading panel 100 and corresponds to the non information-sensing region 143 of the media 14. The second set of optoelectronic device 22B is placed in the reading panel 100 and the through window 225 at the second set of optoelectronic device 22B is adjacent to and communicates with the small through hole 105 at the reading panel 100, as seen in FIG. 4C.

Referring to FIG. 1A, the present invention provides a technology related to interaction between traditional paper books and electronic data. Thus, the present invention can solve problems, having been long in the education field, that students' schoolbags are too heavy and can effectively advance development of human culture and education.

### First Embodiment

### Application to Classrooms

A teaching platform corresponding to a reading panel 100a and a teaching book corresponding to a medium 14a are defined as a leading device. Learning platforms corresponding to reading panels 100b and learning books corresponding to a medium 14b are defined as auxiliary devices.

A teacher can use the optoelectronic reading device to select related contents in the teaching book. Data read by the optoelectronic reading device can be transmitted to the circuit substrate for the central processor and then processed into combined data that can be used to readily search for related reference that can be projected by a projector 70 onto a projecting board 80 so as to be read.

A student can use the optoelectronic reading device to select related contents in the learning book. Data read by the optoelectronic reading device can be transmitted to the circuit substrate for the central processor and then processed into combined data that can be used to readily search for related reference that can be projected by the projector 70 onto the projecting board 80 so as to be read.

No matter whether the teacher teaches or the respective students answer teacher's questions or submit questions, interactive presentations can be performed via an easy operation. Thereby, a learning effect can be improved and the technology in accordance with the present invention is superior to current related technologies.

Referring to FIGS. 3 A and 3B, a subject of a reference is related to Great Wall of China. Electronic files related to the background, sound, pictures and video of Great Wall have been built. When the reference is being read, the second set of optoelectronic device of the reading panel can read index data from the invisible codes on the non information-sensing area of the reference alternatively printed with related information. The index data can be transmitted to the circuit substrate for the central processor for processing the index data. At the same time, positions related to Great Wall can be selected using the optoelectronic reading device. The optoelectronic reading device contains the first set of optoelectronic device that senses and reads coordinate data of the selected contents. The coordinate data can be transmitted to the circuit substrate for the central processor for processing the coordinate data.

Referring to FIG. 5D, the first and second sets of optoelectronic devices and the electronic coordinate circuit obtain processed data, that are, combined data of electronic files, respectively. Thereby, the related contents stored by the electronic files can be readily searched for and a learner can have a realistic experience of Great Wall and reflect the understanding of Great Wall.

Referring to FIGS. 3C and 3D, when a learning book is read, the second set of optoelectronic device of the reading panel can read index data from the invisible codes on the non information-sensing area on a cover or bottom back page of the learning book alternatively printed with related information. The index data can be transmitted to the circuit substrate for the central processor for processing the index data. At the same time, a learner can select from a catalog of the learning book using the optoelectronic reading device. The related contents stored by the electronic files of the catalog can be readily searched for and read.

### Second Embodiment

### Application to Conference Hall

A speech platform corresponding to a reading panel 100a and a speech reference corresponding to a medium 14a are defined as a leading device. Audience platforms corresponding to reading panels 100b and an audience reference corresponding to a medium 14b are defined as auxiliary devices.

A speaker can use the optoelectronic reading device to select related contents in the speech reference. Data read by the optoelectronic reading device can be transmitted to the circuit substrate for the central processor and then processed into combined data that can be used to readily search for related reference that can be projected by a projector 70 onto a projecting board 80 so as to be read.

An audience can use the optoelectronic reading device to select related contents in the audience reference. Data read by the optoelectronic reading device can be transmitted to the circuit substrate for the central processor and then processed into combined data that can be used to readily search for related reference that can be projected by the projector 70 onto the projecting board 80 so as to be read.

A traditional large conference needs various or even dozens of languages. Although there are on-site interpreters, traditional interpretation technologies are far from conveying important points of the speaker because the on-site interpreters cannot know related contents in advance, and thus misleading could happen. Based on the innovative technology of the present invention, the speaker can provide related contents that can be translated in advance for various audiences needing different languages. Thereby, the speaker can control a speech progress so that all audiences can hear suitable languages at the same time and understand actual contents expressed by the speaker.

For a confidential purpose, an electronic card reader has a contactless RF-induction card reading function at the non reading and sensing area of the reading panel. The media may have IC cards, containing storage, at the non information sensing areas thereof. The electronic card reader can read index data in a contactless way from the IC cards of the media. Accordingly, the present invention can be relatively widely used.

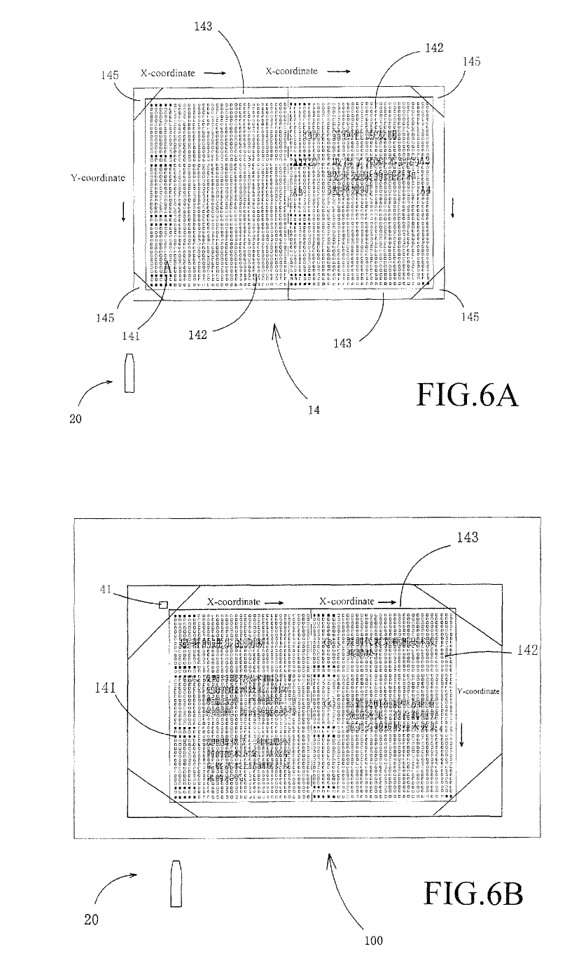

The reading panel 100 has a mechanism for fixing the media 14, as seen in FIGS. 6A and 6B. The reading panel 100 has transparent positioning fixtures at four sides of the reading panel 100. The transparent positioning fixtures may have the media smoothly placed on the reading panel 100. Thus, accuracy of determining a coordinate can be effectively enhanced.

Besides, in accordance with application of the present invention, when the blind read or touch braille words, interaction with listening can be combined. Under equivalent using conditions and effects, a traditional braille-reading publication has a volume and weight that can be reduced up to more than 50%.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. An interactive presentation system for an electronic reading device having an on-paper window system, wherein the interactive presentation system comprises a plurality of electronic reading device, wherein the electronic reading device comprises a reading panel and an electronic card reader, wherein the reading panel has a panel surface having media placed thereon, wherein the electronic card reader comprises an electronic coordinate device, a circuit substrate for a central processor, which is provided with a storage, and multiple sets of optoelectronic devices, wherein the electronic coordinate device comprises an electronic coordinate circuit and an electromagnetic-wave circuit configured to emit a signal with a fixed frequency, wherein a first set of optoelectronic device and the electromagnetic-wave circuit compose an optoelectronic reading device, wherein the optoelectronic reading device and a second set of optoelectronic device are configured to read various data from media, having information messages, and the electronic coordinate circuit, respectively, wherein the data is configured to be transmitted to the circuit substrate for the central processor and then processed into combined data of electronic files, wherein related information is configured to be readily searched for and read using a connected electronic reading product.

2. The interactive presentation system of claim 1, wherein one of the electronic reading devices is set as a leading device, and the others of the electronic reading devices are set as auxiliary devices.

3. The interactive presentation system of claim 1, wherein the reading panel, like a panel-shaped body, is divided into a reading and sensing area and non reading and sensing area, wherein the reading and sensing area corresponds to an effective sensing region of the electronic coordinate circuit in the reading panel, wherein the electronic coordinate circuit is arranged with multiple electronic antenna-array type of circuit substrates having multiple electronic antenna loops alternately formed and overlain with one another, wherein the electronic antenna-array type of circuit substrates comprise a metal line, extending in a direction of X-axis, and another metal line, extending in a direction of Y-axis and across the direction of X-axis, that compose an array type of the antenna loops, wherein the antenna-array type of circuit substrates are configured to sense the signal with the fixed frequency emitted from the electromagnetic-wave circuit and have contacts electrically connected to A/D devices of the circuit substrate for the central processor.

4. The interactive presentation system of claim 1, wherein the reading panel, like a panel-shaped body, comprises a left panel and a right panel configured to join with each other and move apart from a center line such that a clipping space is configured to be kept between the left and right panels, wherein the reading panel is divided into a reading and sensing area and a non reading and sensing area, wherein the reading and sensing area corresponds to an effective sensing region of the electronic coordinate circuit in the reading panel, wherein the left and right panels comprise electrically conductive devices, having opposite polarization, at neighboring sidewalls thereof and are electrically connected to the circuit substrate for the central processor, wherein the electronic coordinate circuit is arranged with multiple electronic antenna-array type of circuit substrates having multiple electronic antenna loops alternately formed and overlain with one another, wherein the electronic antenna-array type of circuit substrates comprise a metal line, extending in a direction of X-axis, and another metal line, extending in a direction of Y-axis and across the direction of X-axis, that compose an array type of the antenna loops, wherein the antenna-array type of circuit substrates are configured to sense the signal with the fixed frequency emitted from the electromagnetic-wave circuit and have contacts electrically connected to A/D devices of the circuit substrate for the central processor.

5. The interactive presentation system of claim 4, wherein each of the left and right panels comprises at least a magnetic block at a corresponding neighboring sidewall thereof, wherein the magnetic blocks of the left and right panels have opposite polarization.

6. The interactive presentation system of claim 1, wherein a standalone electronic device is set at a panel surface of a non information-sensing area of the reading panel.

7. The interactive presentation system of claim 1, wherein the media are divided into an information-sensing region and a non information-sensing region corresponding to the reading and sensing area and non reading and sensing area of the reading panel, respectively.

8. The interactive presentation system of claim 1, wherein the media are printed with invisible codes arranged with multiple minute symbol units printed using a fluorescent ink having optical response to an infrared ray from an infrared emitter, wherein the media having different information-sensing region are not printed with the same invisible code.

9. The interactive presentation system of claim 1, wherein the non information-sensing region is printed with an invisible code, wherein each invisible code is arranged with multiple minute symbol units and is printed using a fluorescent ink having optical response to an infrared ray from an infrared emitter.

10. The interactive presentation system of claim 1, wherein the first set of optoelectronic device comprises an infrared emitter, an image capturing device and a photoelectric conversion circuit, wherein the image capturing device is configured to capture a response image of an invisible code, and the photoelectric conversion circuit is configured to transmit determined data to the circuit substrate for the central processor for processing the determined data, wherein the optoelectronic reading device comprises a functional switch and an output circuit.

11. The interactive presentation system of claim 1, wherein the second set of optoelectronic device comprises an infrared emitter, an image capturing device and a photoelectric conversion circuit and is placed in an internally hollow body, wherein a through window is set at a front end of the internally hollow body, wherein the infrared emitter is configured to emit an infrared ray to the outside via the through window, and the image capturing device is configured to capture an image via the through window, wherein the image capturing device is configured to capture a response image of an invisible code, wherein the photoelectric conversion circuit is configured to transmit determined data to the circuit substrate for the central processor for processing the determined data.

12. The interactive presentation system of claim 1, wherein a small through hole is set at the non reading and sensing area of the reading panel and corresponds to the non information-sensing region of the media, wherein the second set of optoelectronic device is placed in the reading panel and the through window at the second set of optoelectronic device is adjacent to and communicates with the small through hole at the reading panel.
